(19) United States
(12) Patent Application Publication
(10) Pub. No.: US 2019/0100122 A1
(43) Pub. Date: Apr. 4, 2019

(54) WATERPROOF SKINNED BENCH SEAT

(71) Applicant: Ford Global Technologies, LLC, Dearborn, MI (US)

(72) Inventors: Gregory Hagedorn, Bloomfield Hills, MI (US); Timothy Owen Hamlin, Warren, MI (US); Johnathan Andrew Line, Northville, MI (US)

(73) Assignee: Ford Global Technologies, LLC, Dearborn, MI (US)

(21) Appl. No.: 15/724,477

(22) Filed: Oct. 4, 2017

(51) Int. Cl. B60N 2/58; B62J 1/12; B62J 17/00; B60N 2/68

(52) U.S. Cl. CPC B60N 2/58; B62J 1/12; B60N 2/005; B60N 2/68; B62J 17/00

(57) ABSTRACT

A method of making a seating assembly includes attaching an electronics module to a seat support structure. A cushion assembly is formed over the electronics module and secures the cushion assembly to an underlying seat support structure. Connecting features of the cushion assembly are flowed into securing channels of the seat support structure to form an interference fit. The cushion assembly and the underlying seat support structure are covered with a water barrier skin to form a watertight seating unit. A seating surface of the watertight seating unit is covered with a coverstock. The watertight seating unit is secured to a seat frame

### FIELD OF THE DISCLOSURE

The present disclosure generally relates to a bench seat, and more particularly to a waterproof skinned bench seat.

### BACKGROUND OF THE DISCLOSURE

Traditional seating assemblies do not typically include water resistant or water proof constructions. Off-road vehicles may include water resistant secondary seating solutions, but these solutions are generally prohibitively expensive due to the large volume of foam that must be protected. In addition, these solutions do not generally include modern safety features available on road vehicles.

### SUMMARY OF THE DISCLOSURE

According to one aspect of the present disclosure, a method of making a seating assembly includes attaching an electronics module to a seat support structure. A cushion assembly is formed over the electronics module and secures the cushion assembly to the underlying seat support structure. Connecting features of the cushion assembly are flowed into securing channels of the seat support structure to form an interference fit. The cushion assembly and the underlying seat support structure are covered with a water barrier skin to form a watertight seating unit. A seating surface of the watertight seating unit is covered with a coverstock. The watertight seating unit is secured to a seat frame.

According to another aspect of the present disclosure, a method of making a seating assembly includes attaching a cushion assembly to an underlying seat support structure. The cushion assembly and the underlying seat support structure are covered with a water barrier skin to form a watertight seating unit. A seating surface of the watertight seating unit is covered with a trim stock. The watertight seating unit is secured to a seat frame.

According to yet another aspect of the present disclosure, a seating assembly includes a flexible support. A foam cushion is operably coupled with the flexible support. An electronics module is disposed between the flexible support and the foam cushion. Foam connecting features extend from the foam cushion and are operably coupled with channels defined in the flexible support. A watertight skin covers the foam cushion and the flexible support. A coverstock extends over a seating surface defined by the foam cushion.

Embodiments of the first aspect, the second aspect, and the third aspect of the present disclosure, as set forth in the preceding paragraphs, can include any one or a combination of the following features:
chemically bonding a water barrier skin to an underlying seat support structure;
coupling an electronics module with wiring that extends through the seat support structure;
forming a cushion assembly from polyurethane;
operably coupling at least one seat restraint to a watertight seating unit;
forming the watertight seating unit into a bench seat defining first and second seating surfaces with a raised portion disposed between the first and second seating surfaces; and
positioning the watertight seating unit and a seat frame within a vehicle.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front perspective view of a vehicle incorporating a seating assembly of the present disclosure;

FIG. 2 is an enlarged top perspective view of a bench seat of the present disclosure;

FIG. 3 is a top perspective view of the bench seat of FIG. 2 with layers of the bench seat removed;

FIG. 4 is an enlarged cross-sectional view of a cushion assembly for use with a seating assembly of the present disclosure; and

FIG. 5 is an enlarged cross-sectional view of the seating assembly of FIG. 4, prior to application of a coverstock.

### DETAILED DESCRIPTION OF THE EMBODIMENTS

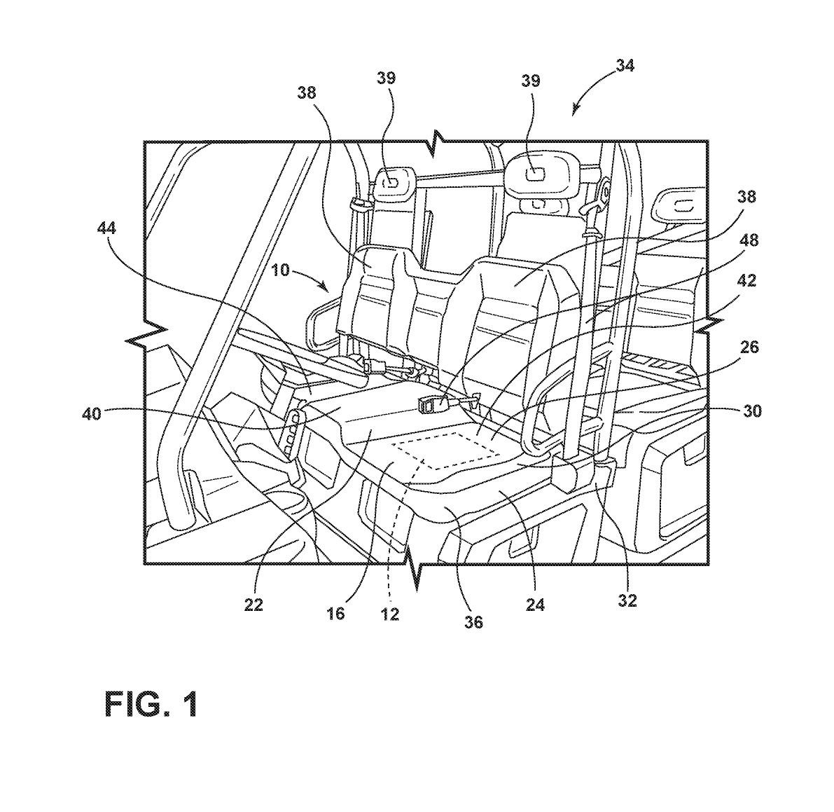

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

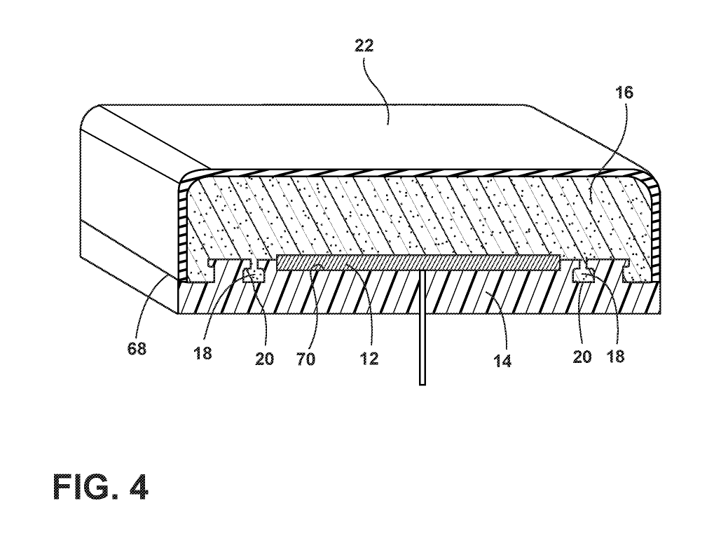

Referring to the embodiment generally illustrated in FIGS. 1-5, reference numeral 10 generally designates a seating assembly. An electronics module 12 is attached to a seat support structure 14. A cushion assembly 16 is formed over the electronics module 12 and secures the cushion assembly 16 to the underlying seat support structure 14. Connecting features 18 (FIG. 4) of the cushion assembly 16 flow into securing channels 20 of the seat support structure 14 to form an interference fit. The cushion assembly 16 and the underlying seat support structure 14 are covered with a water barrier skin 22 to form a watertight seating unit 24. A seating surface 26 of the watertight seating unit 24 is covered with a coverstock 30. The watertight seating unit 24 is secured to a seat frame 32.

With reference again to FIG. 1, the seating assembly 10 is generally configured for use in a vehicle, although other applications are also possible. As illustrated, the seating assembly 10 is positioned within an off-road vehicle 34 that has a generally open construction free of a roof and doors. As a result, the interior of the off-road vehicle 34 is open to the environment, which can lead to excessive wind, rain, and sun exposure on the interior of the off-road vehicle 34. Further, the seating assembly 10 is in the form of a bench seat 36 that is formed as a unitary item. Although the illustrations as set forth herein are directed to the bench seat 36, it will be understood that the same procedures for making the seating assembly 10, as well as the features of the seating assembly 10, also apply to a seatback 38 or a headrest 39, as illustrated in FIG. 1. The seat frame 32 may be exposed, as shown in FIG. 1, or may otherwise be covered by aesthetic panels configured to conceal the seat frame 32. Notably, the seating assembly 10 may be used in the front or rear of the off-road vehicle 34, and is not restricted to a bench seat configuration. The seating assembly 10 may also apply to bucket seats, car seats for infants, and various other seating arrangements configured for use with the off-road vehicle 34 or separate from the off-road vehicle 34. Further, one or more seat restraints 48 may be operably coupled with the watertight seating unit 24.

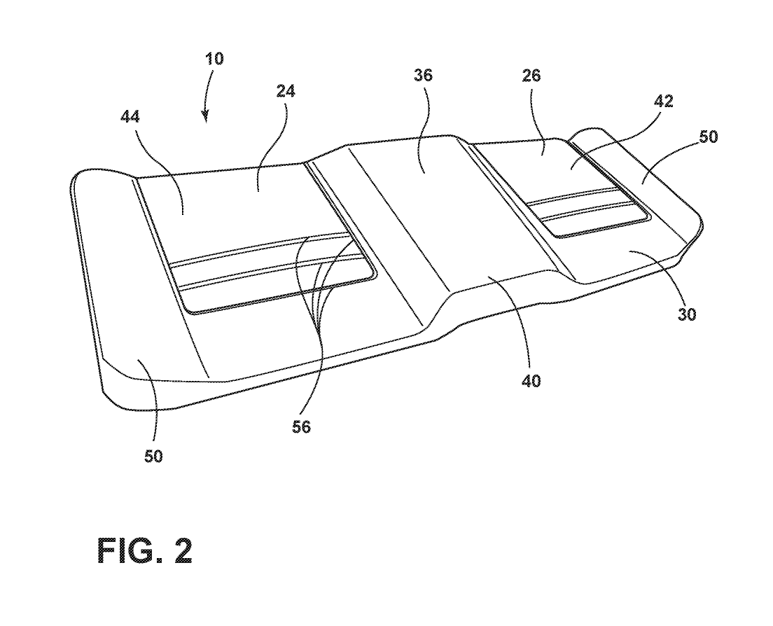

With reference now to FIG. 2, the seating assembly 10 is in the form of the bench seat 36 having the seating surface 26 separated by a raised portion in the form of a central hump 40, which is disposed between a first seating area 42 and a second seating area 44. The central hump 40 may be formed to accommodate a transmission or power train extending below the seating assembly 10, or may be an aesthetic feature that separates the first seating area 42 from the second seating area 44. The bench seat 36 defines the watertight seating unit 24 and is sealed about an entirety of the periphery by the water barrier skin 22. Each side of the bench seat 36 includes a raised bolster 50 configured to abut an outside thigh of a passenger. The central hump 40 is configured to abut an inside thigh of a passenger. In addition, each of the first and second seating areas 42, 44 defines channels 56 configured to provide some degree of air movement through the channels 56 to cool the buttocks of an occupant. It will be understood that the bench seat 36 may take on a variety of other configurations, and that the seating assembly 10 is not limited to this construction. Further, it will be understood that the watertight seating unit 24 may be in the form of the bench seat 36 shown in FIG. 2, or may be in the form of the seatback 38, the headrest 39, etc., as previously noted.

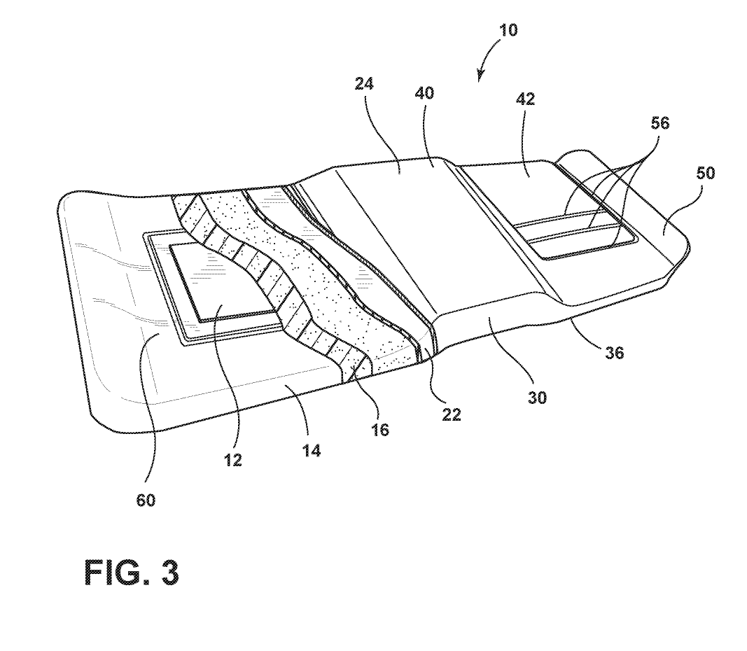

With reference now to FIG. 3, the seating assembly 10, and specifically the watertight seating unit 24, is shown with various layers removed from the seating assembly 10. The seat support structure 14 may be formed from a relatively rigid material, such as plastic, fiberglass, or metal. The shape of a top side 60 of the seat support structure 14 may closely mimic, or otherwise be complementary to, the shape of the seating surface 26. However, it is also contemplated that the seat support structure 14 may include a shape different from the seating surface 26. The shape of the seating surface 26 is generally defined by the cushion assembly 16, which may be thicker or thinner on various portions of the seating assembly 10, depending on the desired application. Notably, as shown in FIG. 3, the water barrier skin 22 is configured to extend all the way around the cushion assembly 16. Accordingly, the water barrier skin 22 provides protection from the elements for the electronics module 12, the seat support structure 14, and the cushion assembly 16. It will be understood that the water barrier skin 22 may be chemically bonded to the underlying seat support structure 14. In addition, the water barrier skin 22 may be thermoformed and bonded directly to the cushion assembly 16. This process may be carried out in a separate operation so that there is no need for any secondary attachments to hold the water barrier skin 22 in place on the seat. It is also contemplated that the water barrier skin 22 may be thermoformed around the foam and onto the seat support structure 14 in the same process at the same time.

With reference now to FIG. 4, the connecting features 18 of the cushion assembly 16 are illustrated. The cushion assembly 16 is constructed from a material that flows into the securing channels 20 when the cushion assembly 16 is formed over the seat support structure 14. The cushion assembly 16 may be formed from any of a variety of materials, such as polyurethane, for example. As the connecting features 18 flow into the securing channels 20 of the seat support structure 14, an interference fit is developed. After the connecting features 18 of the cushion assembly 16 have cured or set, the cushion assembly 16 is then operably coupled with the seat support structure 14. Accordingly, the use of mechanical fasteners or adhesives is not required. However, it will be noted that for certain applications, adhesives or mechanical fasteners could also be used to provide additional connection of the cushion assembly 16 to the seat support structure 14. The electronics module 12 of the seating assembly 10 extends between the cushion assembly 16 and the seat support structure 14. The electronics module 12 includes wiring that extends through the underlying seat support structure 14. The wiring may be integrally formed with the seat support structure 14, or may be drawn through an aperture that extends through the seat support structure 14 and sealed against the aperture after assembly. Alternatively, the water barrier skin 22 may extend all the way around the cushion assembly 16, as well as the seat support structure 14, thereby creating a completely encompassed seat support structure 14. In this instance, the water barrier skin 22 would interface with, and provide a watertight seal against, a periphery of the wiring, as the wiring projects from a bottom side of the seat support structure 14. It should also be noted that a watertight seal is defined at an interface 68 of the water barrier skin 22 and the seat support structure 14.

The electronics module 12 may be configured to provide passenger input to the off-road vehicle 34. More specifically, the electronics module 12 may include a weight sensor to determine passenger occupancy, which can be used for enablement or disablement of safety features within the off-road vehicle 34. The electronics module 12 may be positioned inside a recess disposed on a top surface of the seat support structure 14, as shown in FIG. 4. Alternatively, the electronics module 12 may rest on the seat support structure 14. It is generally contemplated that the addition of adhesives or mechanical fasteners that secure the electronics module 12 to the seat support structure 14 are unnecessary as the cushion assembly 16 holds the electronics module 12 in place on the seat support structure 14. In addition, it is contemplated that retention features similar to the retention features between the cushion assembly 16 and the seat support structure 14 may also be utilized between the electronics module 12 and the seat support structure 14.

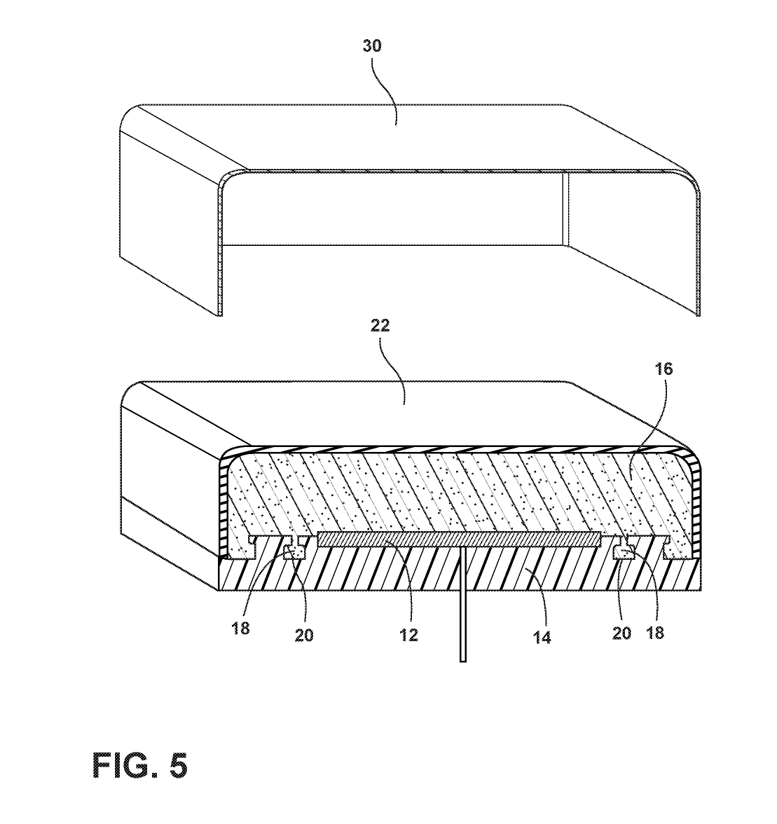

With reference now to FIG. 5, after the water barrier skin 22 has been applied to the cushion assembly 16, the coverstock 30 may be applied to the water barrier skin 22. The coverstock 30 is configured to provide a comfortable interface between the passenger and the seating surface 26. It will be understood that the water barrier skin 22 may be less than comfortable for a passenger during travel, so the coverstock 30 is provided to minimize discomfort to the passenger during travel as the coverstock 30 may be somewhat breathable. The addition of a breathable coverstock to the seating surface 26 results in additional comfort to the occupant. However, it is also possible that the coverstock 30 may be a completely impermeable membrane as well. In applications where the seating structure may be used extensively, in marine-type applications, a coverstock that is breathable and may retain water may be discarded in favor of a non-absorbent coverstock, which will dry quickly after being removed from water.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A method of making a seating assembly, the method comprising:
attaching an electronics module to a seat support structure;
forming a cushion assembly over the electronics module and securing the cushion assembly to the underlying seat support structure;
flowing connecting features of the cushion assembly into securing channels of the seat support structure to form an interference fit;
covering the cushion assembly and the underlying seat support structure with a water barrier skin to form a watertight seating unit;
covering a seating surface of the watertight seating unit with a coverstock; and
securing the watertight seating unit to a seat frame.

2. The method of claim 1, further comprising:
chemically bonding the water barrier skin to the underlying seat support structure.

3. The method of claim 1, further comprising:
coupling the electronics module with wiring that extends through the seat support structure.

4. The method of claim 1, further comprising:
forming the cushion assembly from polyurethane.

5. The method of claim 1, further comprising:
operably coupling at least one seat restraint to the watertight seating unit.

6. The method of claim 1, further comprising:
forming the watertight seating unit into a bench seat defining first and second seating areas with a raised portion disposed between the first and second seating surfaces.

7. The method of claim 1, further comprising:
positioning the watertight seating unit and the seat frame within a vehicle.

8. A method of making a seating assembly, the method comprising:
attaching a cushion assembly to an underlying seat support structure;
covering the cushion assembly and the underlying seat support structure with a water barrier skin to form a watertight seating unit;
covering a seating surface of the watertight seating unit with a trim stock; and
securing the watertight seating unit to a seat frame.

9. The method of claim 8, further comprising:
chemically bonding the water barrier skin to the underlying seat support structure.

10. The method of claim 8, further comprising:
coupling an electronics module with wiring that extends through the underlying seat support structure.

11. The method of claim 8, further comprising:
forming the cushion assembly from polyurethane.

12. The method of claim 8, further comprising:
operably coupling at least one seat restraint to the watertight seating unit.

13. The method of claim 8, further comprising:
forming the watertight seating unit into a bench seat defining first and second seating areas with a raised portion disposed between the first and second seating surfaces.

14. The method of claim 8, further comprising:
positioning the watertight seating unit and the seat frame within a vehicle.

15. A seating assembly comprising:
a flexible support;
a foam cushion operably coupled with the flexible support;
an electronics module disposed between the flexible support and the foam cushion;
foam connecting features extending from the foam cushion and operably coupled with channels defined in the flexible support;
a water barrier skin covering the foam cushion and the flexible support; and
a coverstock extending over a seating surface defined by the foam cushion.

16. The seating assembly of claim 15, further comprising:
wiring operably coupled with the electronics module and extending through the flexible support.

17. The seating assembly of claim 15, wherein the foam cushion is constructed from polyurethane foam.

18. The seating assembly of claim 15, wherein the flexible support includes a receiving cavity for receiving the electronics module.

19. The seating assembly of claim 15, wherein the foam cushion and the flexible support are completely sealed by the water barrier skin.

20. The seating assembly of claim 15, further comprising:
first and second seating areas separated by a raised portion.
